(19) United States
(12) Patent Application Publication
(10) Pub. No.: US 2018/0259170 A1
(43) Pub. Date: Sep. 13, 2018

(54) MULTI-TOOL FLASHLIGHT

(71) Applicant: Shane Keng, Marietta, GA (US)

(72) Inventor: Shane Keng, Marietta, GA (US)

(21) Appl. No.: 15/918,760

(22) Filed: Mar. 12, 2018

Related U.S. Application Data
(60) Provisional application No. 62/470,497, filed on Mar. 13, 2017.
(60) Provisional application No. 62/557,970, filed on Sep. 13, 2017.

(51) Int. Cl. F21V 21/26; B25F 1/04; F21V 23/04; F21L 4/00

(52) U.S. Cl. CPC F21V 21/26; B25F 1/04; F21Y 2115/10; F21L 4/005; F21V 23/0414

(57) ABSTRACT

A multipurpose tool is disclosed herein. The multipurpose tool may include a handle spar, a fold out arm pivotally attached to the handle spar, a flashlight body attachable to the fold out arm, a switch, and a light source. The flashlight body can be configured to be attached and detached from the fold out arm.

### CROSS-REFERENCE TO RELATED APPLICATIONS

The disclosure claims priority to and the benefit of U.S. provisional application No. 62/470,497, filed Mar. 13, 2017, and U.S. provisional patent application No. 62/557,970, filed Sep. 13, 2017, which are both incorporated by reference herein in their entirety.

### FIELD OF THE DISCLOSURE

The disclosure generally relates to a multipurpose tool, and more specifically to a flashlight accessory for use with a multipurpose tool.

### BACKGROUND

Multi-tools are handheld devices configured to store one or more tools within a compact rigid frame. A multi-tool's function and usefulness depend upon which tools are stored within the rigid compartment. A multi-tool commonly has at least one blade, a can opener, and a pair of scissors, among other tools. In addition, multi-tools may include a pair of needle nose pliers, a small saw, and other non-conventional tools. Each of these small tools is contained within an aforementioned rigid compartment. The most common multi-tools are configured to have the tools rotate about one or more pivot points. The tools can be pulled out of the rigid compartment when in use. The tools can then be rotated back into the rigid compartment. One problem with multi-tools is the limited availability for lighting.

### SUMMARY

Some or all of the above needs and/or problems may be addressed by certain embodiments of the multi-tool flashlight disclosed herein. In one aspect, the folding multipurpose tool is provided, including a handle spar and a fold out arm pivotally attached to the handle spar. The fold out arm is configured to fold in and out of a slot in the handle spar. The fold out arm can attach to a flashlight body. The flashlight can have a switch to turn a light source on the flash light on and off. The flashlight body is configured to attach and detach from the fold out arm. The flashlight is also foldable into a closed position within the slot of the handle spar.

In another aspect, a multipurpose tool has a first arm with a first connection point and a second connection point. The multipurpose tool has a second arm that connects to the second connection point of the first arm. The second arm also attaches to a flashlight body.

In yet another aspect, a multipurpose tool has an indented rod with an aft end and a fore end. A rotatable member attaches to the indented rod at the aft end. Additionally, a flashlight selectively attaches to the rotatable member opposite the indented rod aft end.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a front view of a multi-tool flashlight in accordance with one or more embodiments of the disclosure.

FIG. 2A depicts a perspective view of a multi-tool flashlight with storage compartments in accordance with one or more embodiments of the disclosure.

FIG. 2B depicts a perspective view of a multi-tool flashlight with storage compartments in accordance with one or more embodiments of the disclosure.

FIG. 3 depicts an exploded view of a multi-tool flashlight with storage compartments in accordance with one or more embodiments of the disclosure.

### DETAILED DESCRIPTION

Described below are embodiments of a multi-tool for conveniently storing and detaching a flashlight therein. As described herein, multi-tool or multipurpose tool refer to an apparatus that is configured to store one or more tools. Certain illustrative embodiments of the disclosure may be directed towards a folding multipurpose tool comprising a handle spar. The handle spar may, in some instances, form half of the multipurpose tool. A fold out arm may be pivotally attached to the handle spar. The fold out arm may include threads (e.g., male threads) at an end thereof opposite the attachment point to the handle spar. The fold out arm may fold in and out of a slot in the handle spar. The fold out arm may include threads (e.g., male threads) at an end thereof opposite the attachment point to the handle spar. A flashlight body may be attachable to the fold out arm. For example, the flash light body may include threads (e.g., female threads) at an end thereof. The male threads and the female threads may correspond to each other. In this manner, the flash light body may be attached to the fold out arm via the threads. The flashlight body may include a switch on a side thereof for turning the flashlight on and off. For example, the end of the flashlight body opposite threads may include a light source, such as an LED light emitter. The flashlight body may be attached and detached from the fold out arm. When attached to the fold out arm, the flashlight body may be folded into a closed position within the slot of the hand spar, or the flashlight body may be folded into an open position extending away from the slot in the hand spar at various angles, e.g., between 0 and 180 degrees.

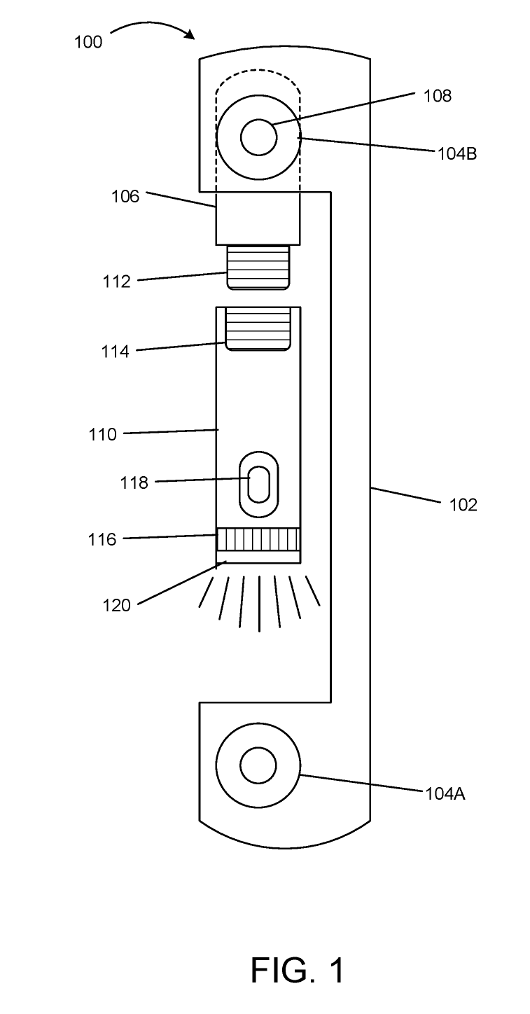

FIG. 1 depicts a front view of a multipurpose tool flashlight 100. In certain embodiments, the multipurpose tool 100 includes a handle spar 102. For example, the handle spar 102 may have at least one connection point 104 that connects to the multipurpose tool (not shown in FIG. 1). In some instances, the handle spar 102 has two connection points 104A and 104B. The connection points 104A and 104B may be configured to rotate freely. In some instances, the connection points 104A and 104B may only rotate as an outside force is applied. The first connection point 104A may connect and rotate to the multipurpose tool. The handle spar 102 may have an indention configured to store various tools. The handle spar 102 stores a flashlight body 110. The handle spar 102 indention may have a series of walls that surround the flashlight body 110. For example, the handle spar 102 indention may close around the flashlight body 110 in a watertight compartment.

In some embodiments, the second connection point 104B is connected to a fold out arm 106 via a pivot. For, example, the fold out arm 106 may connect to the second connection point 104B by a pin 108 threaded through the second connection point 104B about which the fold out arm 106 rotates. The fold out arm 106 may connect to the second connection point 104B by other means, including knuckle joint, turnbuckle, cotter joint, bolted joint, or screw joint. The fold out arm 106 may have a first end that connects to the pin joint 108 and a second end that forms a male threaded connection 112. The threaded connection 112 may be configured to insert into another threaded aperture. For example, a number of tools could be connected to the threaded connection 112, such as a knife, flashlight, wrench, scissors, pliers, screwdrivers, pic, or chisel, among others. One benefit to a threaded connection 112 is the user can switch out various tooling to cater to specific jobs. Another benefit is if a wrench is attached, the fold out arm 106 and the handle spar 102 helps to create a higher moment force at the point of rotation between the wrench and a nut. The fold out arm 106 may be able to rotate up to 90 degrees about the connection point 104B. In some instances, the fold out arm 106 may be able to rotate 180 degrees about the connection point 104B. In other instances, the fold out arm 106 may be able to rotate 360 degrees about the connection point 104B because the handle spar 102 may have an open back channel.

In other embodiments, the fold out arm 106 may selectively attach to a flashlight body 110. The flashlight body 110 has a threaded aperture 114 that is configured to rotate onto the threaded connection 112. The flashlight body 110 may be cylindrical, rectangular, triangular, or some other shape. Within the flashlight body 110 may be a power source (not pictured). The power source may be a button cell, a rectangular battery, or cylindrical battery. The battery may be inserted through the top 116 of the flashlight body 110. The top 116 may connect to the flashlight body 110 by a series of threading on the interior of the top 116 and the exterior of the flashlight body 110. The battery may be similarly inserted through the threaded aperture 114.

The flashlight body 110 has a button 118 configured to turn the light source 120 on and off. The button 118 connects the power source within the flashlight body 110 to the light source 120. For example, the button 118 may be a button switch that completes the circuit between the light source and the power source to turn the light source on 120. The button 118 may also be another switch such as a tailcap switch, a body switch, a twisty (i.e. a bezel is used to turn the flashlight on and off), or some combination thereof. In some embodiments the flashlight body 110 may not have a button, but instead has solely a twisty interface where the top 116 acts as the bezel between on and off positions. The flashlight body 110 rotates about the connection point 104B when connected to the fold out arm 106. Additionally, the flashlight body 110 includes a light source 120. The light source 120 may be a light emitting diode (LED). In some instances the light source 120 may be a light amplified by stimulated emission of radiation (laser) bulb, an incandescent light bulb, or a fluorescent bulb, among others.

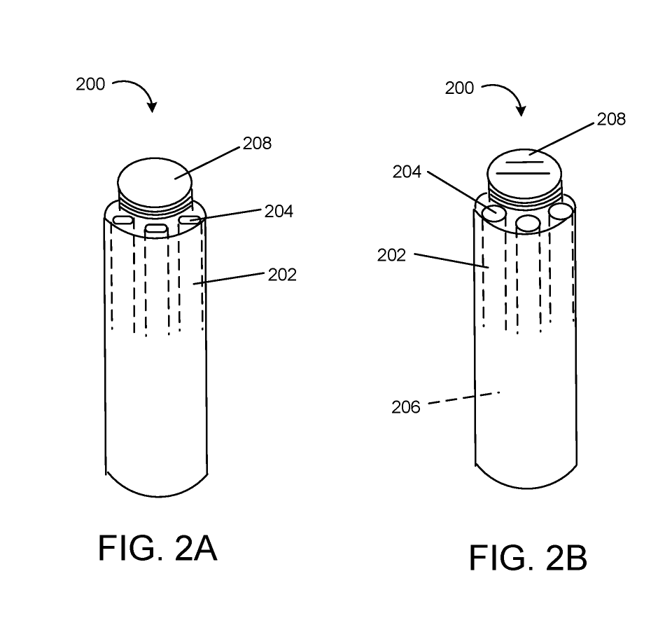

In another embodiment, a flashlight with storage slots is disclosed. As seen in FIGS. 2A and 2B, the flashlight 200 may include a body 202. The body 202 may include one or more elongated storage slots 204 disposed about the circumference of the body 202. In some instances, the elongated storage slots 204 may be disposed around a central battery compartment 206 in the body 202. In certain embodiments, the elongated storage slots 204 may be tubular. In other instances, the elongated storage slots 204 may be rectangular. The elongated storage slots 204 may be any suitable size, shape, or configuration. In some instances, one end of the elongated storage slots 204 may be open while a second end may be closed off. In some instances, the open end of the elongated slots 204 may be closed off by a cap 208 or the like. For example, the cap 208 may be attached (e.g., screwed) onto the body 202, and the periphery of the cap may extend over on or more of the open ends of the elongated slots 204. In other instances, each of the elongated slots 204 may include an individual cap removeably disposed about the open end of the elongated slot 204.

In certain embodiments, the flashlight may be round or square with slots machined into the sides of the outer body around the battery compartment. The slots can be round, oval, or custom inletted and act as storage compartments for auxiliary tools such as lock picks, fire starting rods, etc. The slots may be covered by a twist off tail cap.

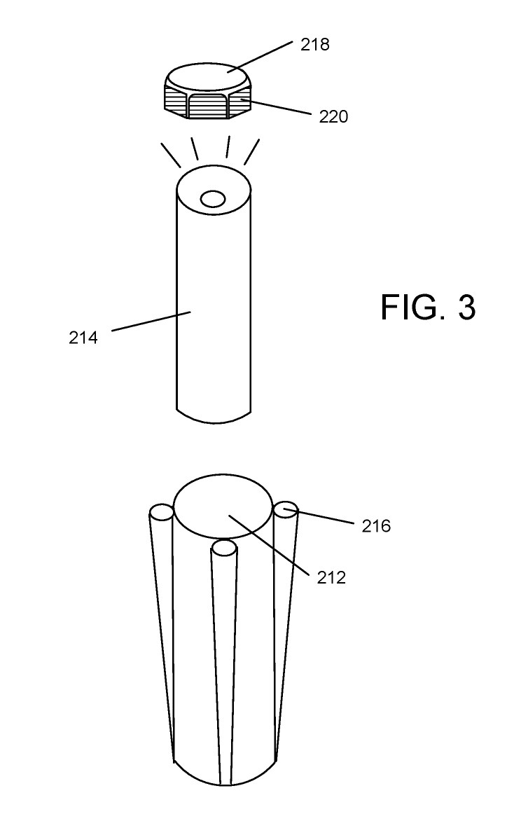

In another embodiment, as depicted in FIG. 3, the elongated slots 216 may be formed within or attached to a storage tube 212. The storage tube 212 may be configured to storage a flashlight 214 therein. In some instances, the flashlight 214 and the elongated slots 216 may be closed off on one end by a cap 220. The cap 220 may include an aperture 218 for light from the flashlight 214 to pass therethrough.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A folding multipurpose tool, comprising:
a handle spar;
a fold out arm pivotally attached to the handle spar, wherein the fold out arm is configured to fold in and out of a slot in the handle spar;
a flashlight body attachable to the fold out arm;
a switch, the switch configured to turn the flashlight on and off;
a light source;
wherein the flashlight body is configured to be attached and detached from the fold out arm, wherein when attached to the fold out arm the flashlight body is foldable into a closed position within the slot of the handle spar.

2. The folding multipurpose tool of claim 1, wherein the light source is selected from the group consisting of an incandescent light bulb, a light emitting diode, a fluorescent bulb, and a light amplified by stimulated emission of radiation bulb.

3. The folding multipurpose tool of claim 1, wherein the switch comprises a push button switch.

4. The folding multipurpose tool of claim 1, wherein the fold out arm comprises male screw threads, wherein the flashlight body comprises female screw threads configured to receive the male screw threads.

5. The folding multipurpose tool of claim 1, wherein the handle spar comprises a pin joint connecting the fold out arm.

6. The folding multipurpose tool of claim 1, wherein the foldout arm is configured to rotate up to 180 degrees.

7. The folding multipurpose tool of claim 1, wherein the foldout arm is configured to rotate up to 360 degrees.

8. A multipurpose tool, comprising:
a first arm, wherein the first arm comprises a first connection point and a second connection point;
a second arm having a first end and a second end, wherein the second end coupled at the second connection point of the first arm; and
a flashlight body coupled to the first end of the second arm.

9. The multipurpose tool of claim 8, wherein the first end of the second arm comprises a threaded portion, the threaded portion configured to bind to the flashlight body.

10. The multipurpose tool of claim 8, wherein the first arm comprises an indention configured to fit the flashlight body within the indention.

11. The multipurpose tool of claim 8, wherein the flashlight body comprises:
a battery contained within the flashlight body;
a power source contained within the flashlight body;
a light source at a first end of the flashlight body;
a switch for operably connecting the light bulb and the power source; and
a threaded aperture.

12. The multipurpose tool of claim 11, wherein the switch for operably connecting the light bulb comprises a push button, the push button configured to provide a current path from the power source to the light bulb.

13. The multipurpose tool of claim 8, wherein the first arm rotates about a pin connection of the first arm at the second connection.

14. The multipurpose tool of claim 11, wherein the light source comprises a light emitting diode.

15. A multipurpose tool, comprising:
an indented rod with a aft end and a fore end;
a rotatable member coupled to the indented rod at the aft end; and
a flashlight selectively coupled to the rotatable member opposite the indented rod aft end.

16. The multipurpose tool of claim 15, wherein the flashlight comprises:
a body, the body having a first end, a middle, and a second end;
a light bulb coupled to the second end;
a switch for connecting a power source to the light bulb;
a aperture, wherein the aperture is configured to receive the rotatable member.

17. The multipurpose tool of claim 15, wherein the rotatable member rotates about the aft end of the indented rod.

18. The multipurpose tool of claim 15, wherein the flashlight is configured to rotate within the indented rod.

19. The multipurpose tool of claim 16, wherein the aperture and the rotatable member comprise screw threads.

20. The multipurpose tool of claim 15, wherein the aft end and the fore end of the indented rod comprise a pin joint, wherein the pin joint at the aft end threads through the rotatable member.
